(19) United States
(12) Patent Application Publication
(10) Pub. No.: US 2006/0135698 A1
(43) Pub. Date: Jun. 22, 2006

(54) Blends of medium density polyethylene with other polyolefins

(75) Inventors: Rodolfo Mier, Pasadena, TX (US); John S. Sczesny, Friendswood, TX (US)

Correspondence Address: FINA TECHNOLOGY INC, PO BOX 674412, HOUSTON, TX, 77267-4412, US

(73) Assignee: Fina Technology, Inc.

(21) Appl. No.: 11/019,060

(22) Filed: Dec. 21, 2004

(51) Int. Cl. C08L 23/04

(52) U.S. Cl. 525/240

(57) ABSTRACT

It has been discovered that the properties of sheet or film materials of medium density polyethylene made using a metallocene catalyst (mMDPE) can be improved by blending the mMDPE with a second polyolefin. The second poly-olefin may be a low density polyethylene (LDPE) or a second, different medium density polyethylene (2dMDPE). Improvements include, but are not necessarily limited to, reduced motor amps, a reduction in sealing temperature, and an increase in machine direction tear resistance as compared with an identical material absent the second polyolefin. These sheet or film materials may be co-extruded with other resins or laminated with other materials after extrusion.

### FIELD OF THE INVENTION

The present invention is related to methods and compositions useful to improve the manufacture of sheets or blown films containing polyethylene. It relates more particularly to methods for making blends of copolymers with LDPE to improve the characteristics thereof, as well as to the resulting film and sheet materials.

### BACKGROUND OF THE INVENTION

Among the different possible ways to convert polymers into films, the blown film process is probably the most economical and also the most widely used. This is because films obtained by blowing have a tubular shape which makes them particularly advantageous in the production of bags for a wide variety of uses (e.g. merchandise bags, high quality printed bags, pouches, heavy duty shipping sacks, shrink films, collation shrink films, overwraps, bags for urban refuse, bags used in the storage of industrial materials, for frozen foods, carrier bags, etc.) as the tubular structure enables the number of welding joints required for formation of the bag to be reduced when compared with the use of flat films, with consequent simplification of the process. The biaxial orientation and cooling conditions imposed during film blowing to specific viscoelastic polyethylene resin(s) results in the film properties needed in a given application. Moreover, the versatility of the blown-film technique makes it possible, simply by varying the air-insufflation parameters, to obtain tubular films of various sizes.

Currently over 21 billion pounds of plastics are used in the U.S. each year for packaging. Medium density polyethylene (MDPE) blown films represent a substantial portion of this total. The blown film process is a diverse conversion system used for polyethylene. ASTM defines films as being of less than 0.254 mm (10 mils) in thickness; however, the blown film process can produce materials as thick as 0.5 mm (20 mils). Usage of monolayer and multilayer coextrusion technologies lay the groundwork for the many possibilities to approach a specific application or need. It is important to produce MDPE films having high melt strength, good mechanical properties, and ease of processing that enable blown extrusion in structures with good bubble stability.

Some resin suppliers have patents relating to monolayer and multilayer structures made using MDPE. Several applications are mentioned including industrial bags, bags for frozen foods, carrier bags, heavy-duty shipping sacks, mailing envelopes, shrink films, among others. There is a constant need for materials having improved properties for particular applications.

It would be desirable if methods could be devised or discovered to provide MDPE film or sheet materials having improved properties and ease of processing.

### SUMMARY OF THE INVENTION

There is provided, in one form, a film or sheet material from a blend of at least one medium density polyethylene made using a metallocene catalyst (mMDPE) and from about 10 to about 90 wt % of at least one second polyolefin. The second polyolefin may be a low density polyethylene (LDPE) and/or a second medium density polyethylene (2dMDPE).

In another embodiment of the invention, there is provided a copolymer resin blend having at least one mMDPE and from about 10 to about 90 wt % of at least one second polyolefin. Again, the second polyolefin may be a LDPE, and/or a second medium density polyethylene (2dMDPE).

In yet another embodiment of the invention, there is provided a process for making a blown film that includes blending at least one mMDPE with from about 10 to about 90 wt % of at least one second polyolefin. The second polyolefin may be a LDPE, and/or a second MDPE. The process further involves feeding the polymer blend to an extruder and extruding the polymer blend through an annular die to form a molten tube. The tube is blown into a bubble using air to form a blown film structure.

In further embodiments of the invention, the resin blends herein are co-extruded with other resins for forming a multi-layer film or sheet material. Additionally, film or sheet materials made from the resin blends of this invention may be laminated to a second sheet or film material to make a laminated article.

### BRIEF DESCRIPTION OF THE DRAWINGS

FIG. 1 is a plot of hot tack results at 250 msec for 1.7 mil (43 μ) films of Examples 1-6 produced on an Alpine extruder;

FIG. 2 is a plot of hot tack results at 500 msec for 1.7 mil (43 μ) films of Examples 1-6;

FIG. 3 is a plot of hot tack results at 250 msec for 2.7 mil (68 μ) films of Examples 1-6;

FIG. 4 is a plot of hot tack results at 500 msec for 2.7 mil (68 μ) films of Examples 1-6;

FIG. 5 is a graph of the heat seal force for 1.7 mil (43 μ) films of Examples 1-6;

FIG. 6 is a graph of the heat seal force for 2.7 mil (68 μ) films of Examples 1-6;

FIG. 7 is a graph of the heat seal temperature corresponding to 0.77 N/cm for the mMDPE/LDPE blends of Examples 1-6;

FIG. 8 is a chart of the tear resistance as obtained for Elmendorf tests for films made from the Example 1-6 resins;

FIG. 9 is a plot of the tensile strengths (yield and break) for 1.7 mil (43 μ) films of Examples 1-6;

FIG. 10 is a graph of the graph of the tensile strengths (yield and break) for 2.7 mil (68 μ) films of Examples 1-6;

FIG. 11 is a graph of the tensile elongation for 1.7 mil (43 μ) films of the resins of Examples 1-6;

FIG. 12 is a graph of the tensile elongation for 2.7 mil (68 μ) films of the resins of Examples 1-6;

FIG. 13 is a plot of the secant modulus for 1.7 mil (43 μ) films of the resins of Examples 1-6;

FIG. 14 is a plot of the secant modulus for 2.7 mil (68 μ) films of the resins of Examples 1-6;

FIG. 15 is a chart of the machine and transverse direction tear for 1.5 mils (38μ) HL328/M 3410 EP films of this invention;

FIG. 16 is a chart of gloss and haze results for the 1.5 mils (38μ) HL328/M 3410 EP film blends;

FIG. 17 is a chart of seal initiation temperatures for the 1.5 mils (38μ) HL328/M 3410 EP film blends of this invention;

FIG. 18 is a plot of heat seal force curves for the 1.5 mils (38μ) HL328/M 3410 EP film blends;

FIG. 19 is a chart of the tensile properties for the 1.5 mils (38μ) HL328/M 3410 EP film blends;

FIG. 20 is a chart of the elongation resulting from the tensile deformation imposed on the 1.5 mils (38μ) HL328/M 3410 EP film blends; and

FIG. 21 is a chart of the machine and transverse direction secant modulus obtained from tensile tests on the 1.5 mils (38μ) HL328/M 3410 EP film blends.

### DETAILED DESCRIPTION OF THE INVENTION

It has been discovered that medium density polyethylene polymerized using metallocene catalysts (mMDPE), mMDPE such as, but not limited to TOTAL PETROCHEMICAL's M 3410 EP (ER 2245) polyethylene, can be advantageously blended with other polyolefins to give blown films and sheet materials having improved properties and processability. Several different blends involving M 3410 EP polyethylene mixed with other, second polyolefins include, but are not necessarily limited to, LDPE, and/or a second, different medium density polyethylene (2dMDPE), etc. that improve or change properties including, but not necessarily limited to, reduced motor amperes, a reduction in sealing temperature, a broader heat sealing window, an increase in machine direction (MD) tear resistance, modified impact resistance, gloss, haze, and other physical and mechanical properties. These studies will help to develop expertise in blown film that will support polyethylene businesses and result in novel blends and film and sheet materials.

The metallocene-catalyzed medium density polyethylene (mMDPE) that is modified with a second polyolefin in the context of this invention may be one having a melt index (MI₂) of from about 0.25 to about 9.0 dg/min, a density of about 0.915 to about 0.949 gr/cm³, a melting point of about 115 to about 125° C., and polydispersity Mw/Mn of less than 4.0. Metallocene-based resins falling within this definition include, but are not necessarily limited to TOTAL PETROCHEMICALS's M 3410 EP (ER 2245), ER 2277, ER 2281, ER 2278 and ER 2279 medium density polyethylene resins. In one non-limiting embodiment of the invention, the mMDPE that is modified with a second polyolefin in the context of this invention may be one having a melt index (MI₂) of from about 0.20 to about 20.0 dg/min, a density of about 0.905 to about 0.961 gr/cm³, a melting point of about 100° C. to about 135° C. In an alternative embodiment, the mMDPE may be from about 0.925 to about 0.939 gr/cm³.

Methods for making mMDPE are well known in the art. The term metallocene polyethylene generally denotes polymers obtained by copolymerizing ethylene and an alpha-olefin, such as propylene, butene, hexene or octene, in the presence of a monosite catalyst generally consisting of an atom of a metal which may, for example, be zirconium or titanium, and of two cyclic alkyl molecules bonded to the metal atom. More specifically, the metallocene catalysts are usually composed of two cyclopentadiene-type rings bonded to the metal atom. These catalysts are often used with aluminoxanes as cocatalysts or activators, preferably methylaluminoxane (MAO). Hafnium may also be used as a metal to which the cyclopentadiene is bound. Other metallocenes may include transition metals of groups IV A, V A and VI A. Metals of the lanthanide series may also be used. However, the invention is not limited to any particular metallocene catalyst.

The mMDPE may be blended with from about 10 to about 90 wt % of a second polyolefin, and in another non-limiting embodiment is blended with about 20 to about 80 wt % of the second polyolefin. In an alternate non-limiting embodiment, from about 30 to about 70 wt % of the second polyolefin is used, and further the proportion of the second polyolefin may range from about 40 wt % to about 60 wt %. As will be seen, in particular non-limiting embodiments, certain improved properties may be obtained if the second polyolefin ranges from about 75 to about 95 wt %. All of these proportions are based on the total amount of the over-all blend. That is, the proportion of the first polyolefin to the second polyolefin may range from about 5:95 to about 95:5 or alternatively from about 10:90 to about 90:10 or in another non-limiting embodiment from about 20:80 to about 80:20 or in a different non-restrictive embodiment from about 30:70 to about 70:30 or alternatively from about 40:60 to about 60:40.

One of the polyolefins that can be advantageously blended with the mMDPE is LDPE. The LDPE may be characterized but not limited to a melt index (MI₂) of from about 1.5 to about 2.6 g/10 min, a density of about 0.918 gr/cm³ to about 0.928 gr/cm³, a melting point of about 110 to about 125° C. and a tensile modulus from about 25 to about 35 kpsi. Alternatively, the LDPE may be characterized by a melt index of from about 0.20 to about 20.0 g/10 min, a density of about 0.900 gr/cm³ to about 0.925gr/cm³, a melting point of about 95 to about 125° C. LDPE may also be produced according to processes and methods well known in the art. The LDPE and MDPE may be made by any known or future processes including but not necessarily limited to catalyzed processes, high pressure processes, and the like. Further, LDPE and MDPE made with low comonomer contents including, but not necessarily limited to EVA (ethylene-vinyl acetate), EBA (ethylene-butyl acrylate) and EMA (ethylene-methyl acrylate).

In the case where the second polyolefin is a different or second medium density polyethylene, the polyethylene is made using catalysts already described and techniques already described or well known in the art. In one non-limiting embodiment, the MDPE suitable herein has a melt index (MI₂) of from about 0.1 to about 0.6 dg/min, a density of about 0.925 to about 0.947 gr/cm³, a melting point of about 120 to about 132° C. Alternatively, the 2dMDPE may have a melt index (MI₂) of from about 0.20 to about 10 dg/min, a density of about 0.925 to about 0.950 gr/cm³, a melting point of about 120° C. to about 130° C.

The blends of the present invention may be prepared using technologies known in the art, such as the mechanical mixing of the polyolefins using high-shear internal mixers of the Brabender type, or by mixing them in pellet form to be further mixed directly in the extruder. Although special blending equipment and techniques are acceptable within the scope of this invention, in one non-limiting embodiment the blends are made using the conventional extruders associated with blown film production lines.

The blends of the present invention may also contain various additives capable of imparting specific properties to the articles the blends are intended to produce. Additives known to those skilled in the art that may be used in these blends include, but are not necessarily limited to, fillers such as talc and calcium carbonate, pigments, antioxidants, stabilizers, anti-corrosion agents, antistatic agents, slip agents, and antiblock agents, etc.

It will also be appreciated that the resin blends of this invention may be co-extruded with other resins to form multilayer films. The resin blends herein may serve as the internal layer or the skin layer, and in a particular non-limiting embodiment serve as an internal layer, depending upon the expected application. The co-extrusion may be conducted according to methods well known in the art. Furthermore, the film or sheet materials of this invention may be laminated with other materials after extrusion as well. Again, known techniques in laminating sheets and films may be applied to form these laminates.

The invention will now be described further with respect to actual Examples that are intended simply to further illustrate the invention and not to limit it in any way.

### EXAMPLES 1-6

### LDPE Blended with mMDPE

TOTAL PETROCHEMICALS M 3410 EP mMDPE was blended with a LDPE (MI₂=2) at increments of 20%; please see Table I. The blends were processed on a Alpine blown film line and the films produced (1.7 and 2.7 mils; 43 and 68 microns, respectively) were tested for tear strength, seal strength, tensile strength, secant modulus, HSIT (heat seal initiation temperature), hot tack, gloss, and haze. There is a special interest in finding a LDPE content at which properties are acceptable for a given application. The test results obtained for the films produced in this project will be valuable to assess the effect that LDPE has when blended with mMDPE.

Materials for Examples 1-6

Pellets of M 3410 EP mMDPE and the LDPE were used to prepare the blends. M 3410 EP (MI₂=0.9) is a commercial metallocene-based medium density polyethylene for blown film applications available from TOTAL PETROCHEMICALS. The films produced with the material are characterized by their clarity, gloss, haze, toughness, soft-feel, stiffness, processability and broad heat-seal range.

TABLE I
M 3410 EP mMDPE/LDPE Blends

| | % Weight | % Weight |
|---|---|---|
| Sample | mMDPE | LDPE |
| 1 | 100 | 0 |
| 2 | 80 | 20 |
| 3 | 60 | 40 |
| 4 | 40 | 60 |
| 5 | 20 | 80 |
| 6 | 0 | 100 |

Blown Film Processing

The resins were processed on an Alpine extruder at 100 rpm. The take-up speed was set at 16 and 24 m/min to produce 2.7 and 1.7 mils films, respectively (68 and 43 microns, respectively). The amount of air used to make the bubble produced a 18.6 inches (47.2 cm) layflat (blow up ratio of 2.55). The blower speed was regulated to achieve 0″ (0 cm) neck height. The die gap was 0.9 mm. Runs were first made using a 375/380/380/360/360/360° F. temperature profile (191/193/193/182/182/182° C.). mMDPE (Example 1) was processed first with good stability. It was noticed that the frost line was approximately 12 inches (30.5 cm) in height. The transition to Example 2 (80% mMDPE/20% LDPE) cause the neck and the frost line to go up; therefore, the air was increased (from 39.62 Hz to 45.75 Hz) to achieve the same frost line and neck heights.

Table II shows the melt temperatures, pressures, and motor amperes generated during the extrusion. An interesting behavior was observed with the first 20% addition of LDPE (Example 2), which exhibited the highest pressures and motor amperes, while greater contents of LDPE showed that the extrusion pressures and the motor amperes required for extrusion decrease as the % of LDPE is increased.

TABLE II
Pressures and Amperes Generated on the Alpine Extruder

| | | | Pressure | |
|---|---|---|---|---|
| | | Pressure | after | |
| | Melt | before | screen | |
| | Temp | screen | pack | Motor |
| EXAMPLE | (° F.) | pack (psi) | (psi) | Amperes |
| 1 (100% mMDPE/0% LDPE) | 430.3 | 4150 | 2950 | 21.75 |
| 2 (80% mMDPE/20% LDPE) | 411.0 | 4900 | 3270 | 22.8 |
| 3 (60% mMDPE/40% LDPE) | 410.5 | 4740 | 3140 | 20.8 |
| 4 (40% ER2245/60% LDPE) | 419.16 | 4230 | 2860 | 19.0 |
| 5 (20% ER2245/80% LDPE) | 412.3 | 3470 | 2380 | 17.2 |
| 6 (0% ER2245/100% LDPE) | 405.4 | 2870 | 1900 | 16.2 |

The films produced on the Alpine were tested for hot tack, heat seal, tear strength, gloss and haze, and tensile strength.

Hot Tack Results

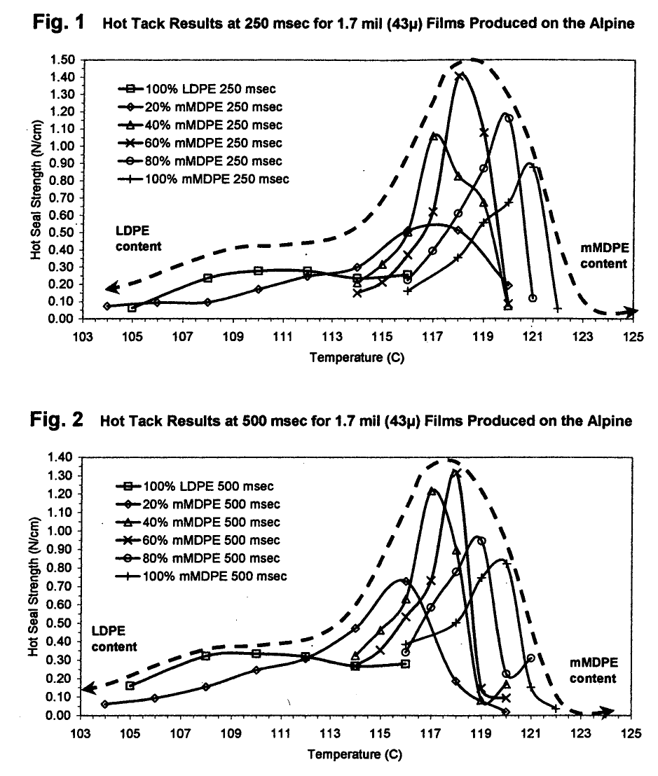

FIGS. 1 and 2 show for the 1.7 mils (43μ) films the hot tack plot (hot seal strength versus temperature) at 250 and 500 msec, respectively. Similar conclusions can be made regardless of the hot tack time. In both cases, an optimum content of LDPE for maximum hot seal strength happens at 40% where the hot tack curve is the narrowest. For the broadest hot tack curve, the optimum content of LDPE is 80%. As the mMDPE content increases, the temperature required for seal initiation is higher without increasing further the hot seal strength. The dotted line shows the hot tack range that can be possible with the prepared compositions. The low temperature tail of the composite curve resembles that of LDPE resin alone, while the high temperature tail is given by the mMDPE resin.

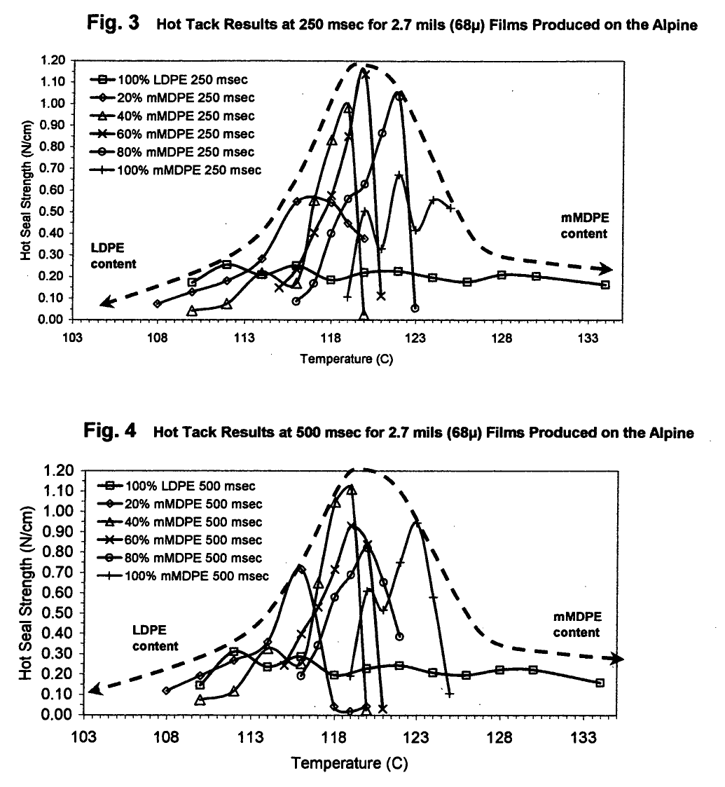

FIGS. 3 and 4 show the hot tack plots for the 2.7 mils (68μ) films. Similar conclusions can be made for the 2.7 mils films.

Heat Seal Results

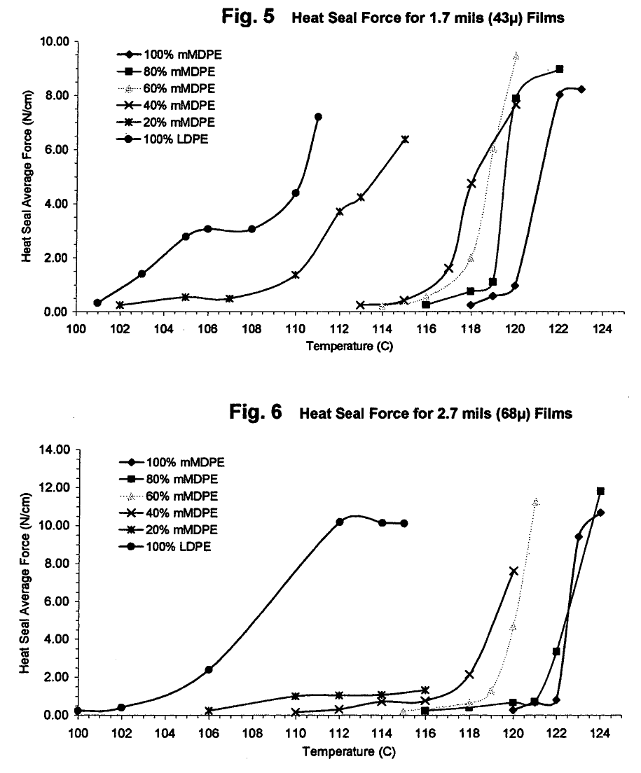

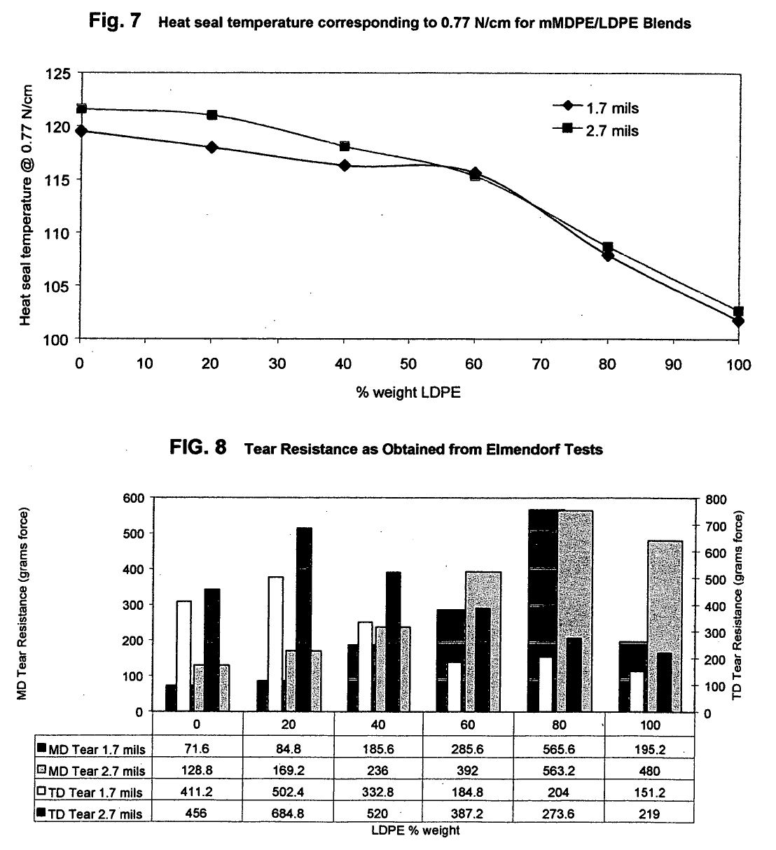

FIGS. 5 and 6 show the heat seal curves for the 1.7 mils (43μ) and 2.7 (68μ) mils films, respectively. As a rule of thumb, the temperature that corresponds to 0.77 N/cm is close to the heat seal initiation temperature (see FIG. 7). As the LDPE weight percentage increases, the temperature required for sealing also decreases. This is in agreement with the hot tack results. Other data show the heat seal window from initiation to “burn through” is 60° C. The result of blending the two polyethylene components mentioned therein is the lower seal initiation temperature coupled a broad sealing window. This provides a broader operating range for the end-use packaging.

Elmendorf Tear Resistance

FIG. 8 shows for the all blends the tear resistance results of the films produced on the Alpine. The machine direction tear resistance increases as the LDPE content increases up to a peak LDPE content between 80% and 100%. For LDPE contents greater than 20%, the TD decreases as the LDPE content increases. The TD/MD tear ratio is maximum at 20% LDPE. An increase in tear resistance is important to the ability to down gauge these films.

Tensile Tests

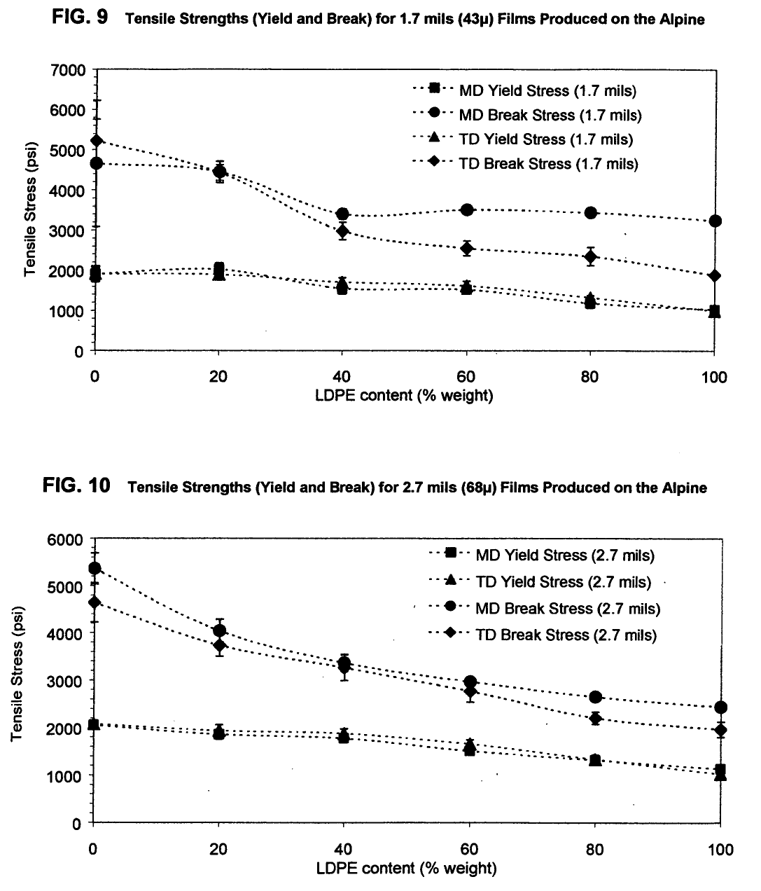

Mechanical tensile tests were conducted on an Instron tester. The yield strength represents the minimum stress required for plastic (non-elastic) deformation. FIGS. 9 and 10 show the yield and break stresses for 1.7 and 2.7 mils films (43 and 68 μ), respectively. No large differences were observed between the MD yield and the TD yield strength, while some differences can be observed between the MD break and the TD break strength. Furthermore, as the LDPE content increases the yield strength decreases from 2000 psi down to 1000 psi (13.8 to 6.9 MPa) and the break strength decreases from 5000 psi down to 3000 psi (34.5 to 20.1 MPa).

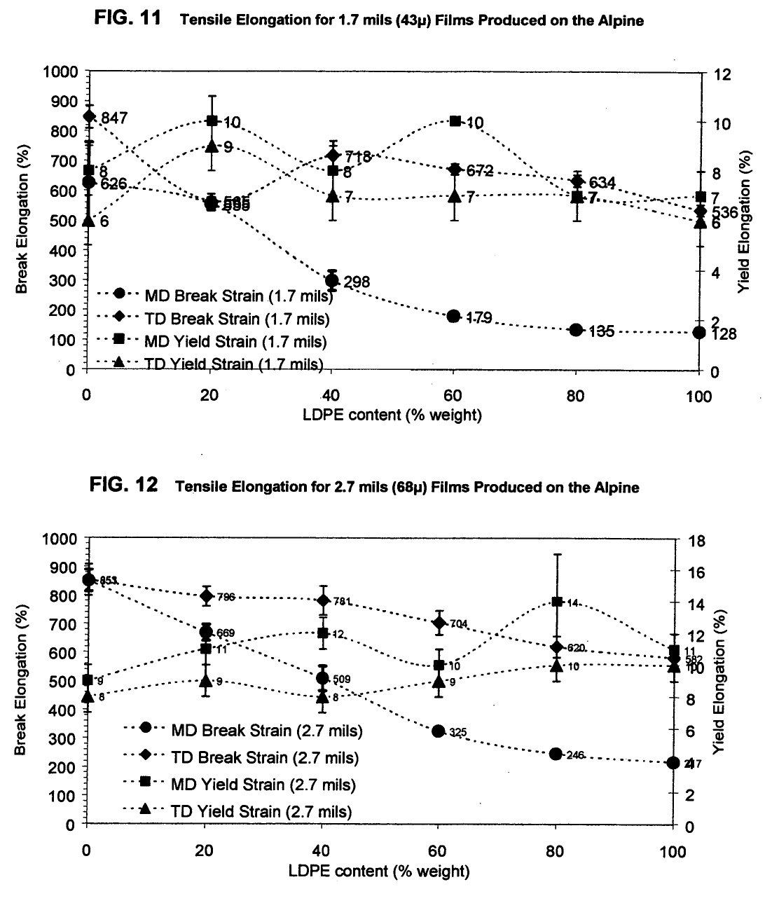

FIGS. 11 and 12 show the yield elongation and the break elongation for 1.7 and 2.7 mils films, respectively (43 and 68 μ, respectively). No clear trend can be distinguished between the tensile strain and the LDPE content.

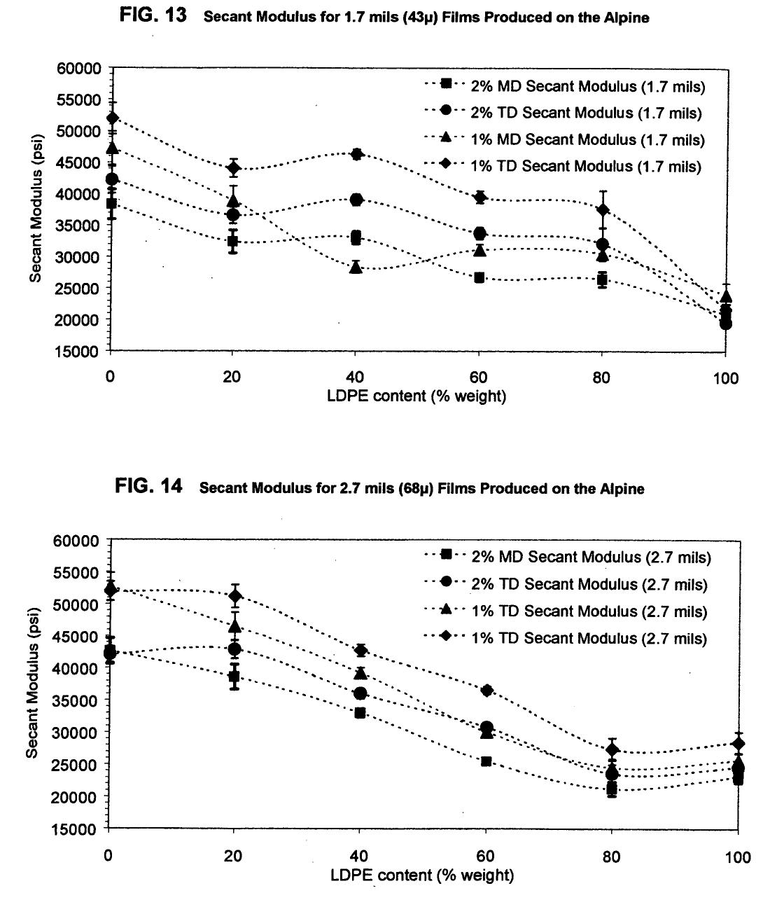

FIGS. 13 and 14 show the secant modulus for 1.7 and 2.7 mils films, respectively (43 and 68 μ, respectively). The shape of the secant modulus curves at 1 % and 2% were very similar, suggesting the tests were carried out correctly. In general, the secant modulus increases as the LDPE content decreases. As a modulus (a property of the material), the secant modulus was nearly independent of the film thickness.

In summary, the mMDPE/LDPE blends of prepared in Examples 2-5 had good processability on the Alpine extruder. The blend of Example 2 with the first 20% addition of LDPE exhibited the highest extrusion pressures and motor amperes, while greater contents of LDPE caused a reduction of the pressure and the motor amperes during extrusion.

Heat seal and hot tack tests show that as the content of LDPE increases, the sealing decreases; but the strength of the seal is lower. Hot tack results indicate that an optimum content of LDPE for maximum hot seal strength happens at about 40% (optionally from about 35 to about 45 wt %) where the hot tack curve becomes the narrowest.

It was observed that the machine direction tear resistance increases as the LDPE content increases, but only up to a critical LDPE content (between about 80% and about 95%, even up to 100%). The TD/MD tear ratio is maximum at about 20% LDPE (in one non-limiting embodiment from about 15 to about 25 wt %).

Tensile tests indicate that as the LDPE content increases the yield strength decreases down to 50%. No significant differences were observed between the MD yield and the TD yield strength, but there are some differences between the MD break and the TD break strength.

### EXAMPLES 7-11

Pellet blends of TOTAL PETROCHEMICALS M3410 EP mMDPE in TOTAL PETROCHEMICALS FINATHENE HL 328 MDPE (a second MDPE in accordance with this invention) were prepared and processed on the Alpine extruder to produce 1.5 mil (38 p) films. The blends were 75/25, 50/50, 25/75 blends of HL 328/ M3410 EP. The films produced were tested for tear resistance, heat seal, tensile strength, gloss, and haze.

Materials for Examples 7-11

A HL 328 MDPE and a M3410 EP blend were used for these Examples. Pellet blends were prepared at 75/25, 50/50, and 25/75% weight, as well as each resin alone. FINATHENE HL 328 is a 0.937 gr/cc MDPE while M3410 EP is a metallocene-based resin. Table III presents the melt indexes and density of the resins used for the study while Table IV presents the molecular weight moments as obtained from GPC. HLMI refers to high load melt index.

TABLE III
Resins used in Examples 7-11 and Their Main Properties

| | MI2 | MI5 | HLMI | Density |
|---|---|---|---|---|
| | dg/min | dg/min | dg/min | g/cc |
| HL 328 | 0.33 | 1.37 | 23.1 | 0.936 |
| M3410 EP | 0.95 | 3.05 | 27.9 | 0.934 |

TABLE IV
Molecular Weight Moments for MDPE HL328 and M3410 EP

| Resin | Mn | Mw | Mz | Mw Peak | Mw/Mn |
|---|---|---|---|---|---|
| HL328 | 15,960 | 182,200 | 1,534,500 | 56,800 | 11.4 |
| M3410 EP | 29,300 | 82,400 | 177,800 | 63,000 | 2.8 |

Alpine Extruder Processing

The two resins and the blends prepared were processed on the Alpine at 100 rpm, 400° F. (204° C.), 2.1 BUR (Blow Up Ratio; 16″ (41 cm) layflat), 0″ neck to produce 1.5 mils (38 μ) films. Table V presents the processing variables during the extrusion of the resins. Due to the higher molecular weight of HL 328 as compared to M3410 EP (see Table IV) the extrusion pressures were higher as the percentage of HL 328 was increased.

TABLE V
Processing Variables during Alpine Extrusion

| | | Pressure | Pressure | |
|---|---|---|---|---|
| | | Before, | After, | |
| | Melt Temp., | Lb/in² | Lb/in² | |
| Resin | ° F. (° C.) | (MPa) | (MPa) | Amperes |
| 100% M3410 EP | 458 (237) | 4300 (29.6) | 2650 (18.3) | 21.2 |
| 75% M3410 EP/ | 457 (236) | 4490 (31.0) | 2750 (18.9) | 21.53 |
| 25% HL 328 | | | | |
| 50% M3410 EP/ | 459 (237) | 4920 (33.9) | 2910 (20.1) | 22.1 |
| 50% HL 328 | | | | |
| 25% M3410 EP/ | 455 (235) | 5060 (34.9) | 3180 (21.9) | 22.6 |
| 75% HL 328 | | | | |
| 100% HL 328 | 453 (234) | 5050 (34.8) | 3280 (27.6) | 22.66 |

Film Properties

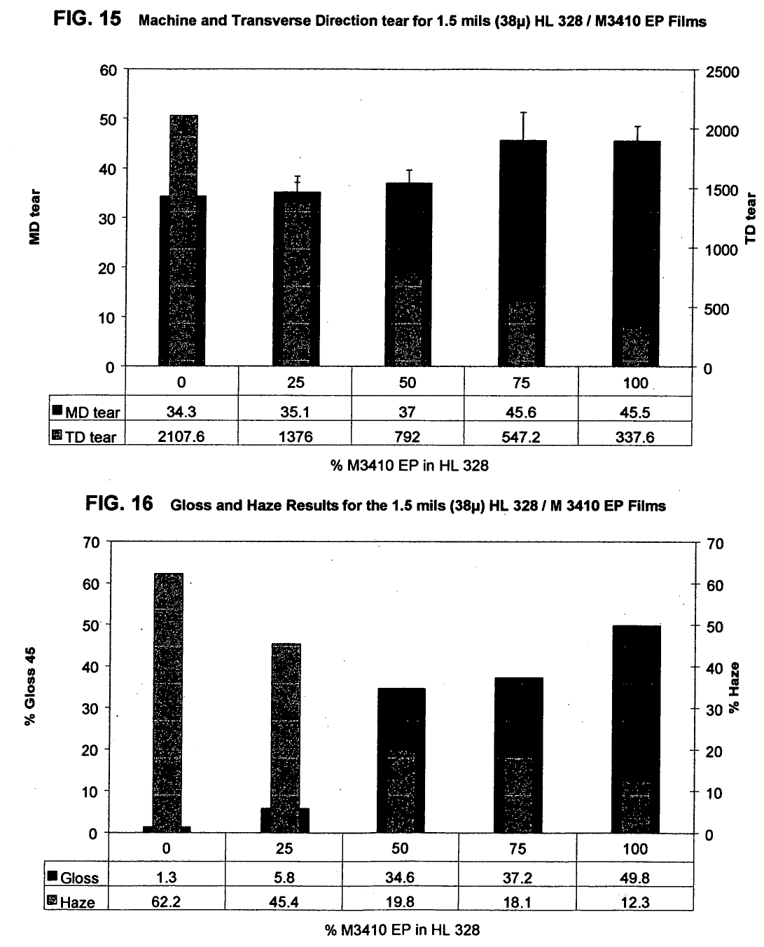

The films produced were tested for WVTR, Elmendorf tear, heat seal, tensile strength, gloss, and haze. FIG. 15 plots the machine and transverse direction tear for the HL 328/M3410 EP films. The transverse direction tear progressively decreases from about 2100 grf for 100% HL 328 to about 340 grf for 100% M3410 EP as the amount of M3410 EP increases. The opposite happens in the MD tear but the change in tear is much less.

FIG. 16 presents the gloss and haze results for the same HL 328/M3410 EP films. As the amount of M3410 EP increases, the gloss significantly improves (not linearly) and the haze value significantly decreases. Excellent gloss and haze results (close to those of 100% M3410 EP) can be obtained when blending 50 to 75% M3410 EP in HL 328. The same holds true for the tear properties.

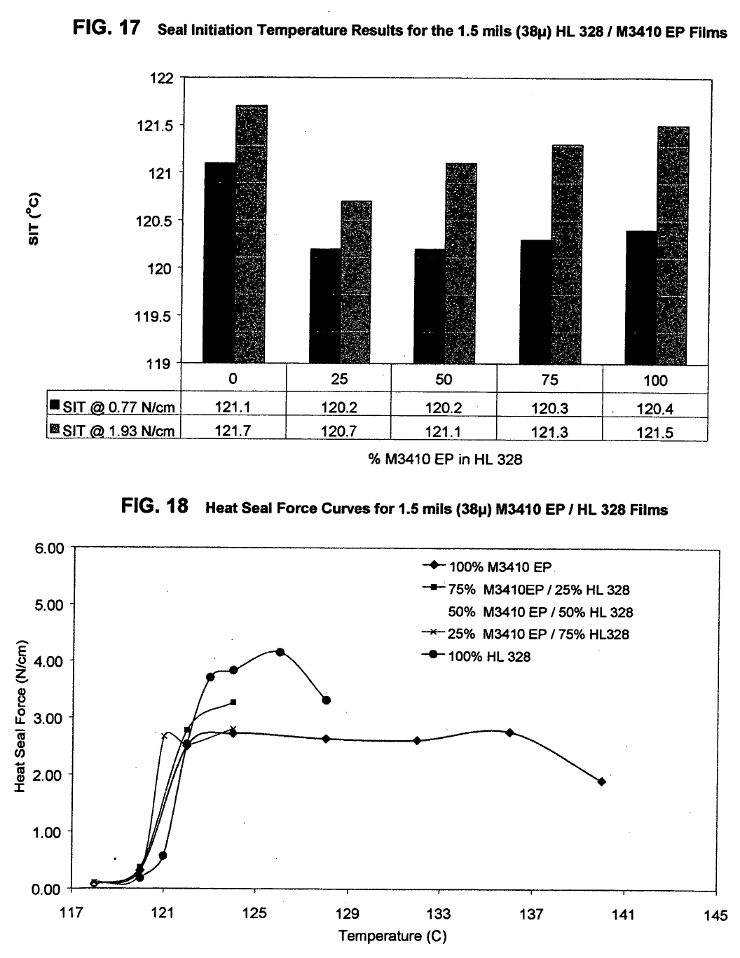

FIG. 17 presents the seal initiation temperature for the 1.5 mils (38 μ) HL 328/M3410 EP films. Although it would seem that increasing M3410 EP content marginally increases the SIT, the results are within the experimental error of the test; therefore, it can be concluded that the SIT is not especially affected by blending M3410 EP and HL328 regardless of the blend percentage.

FIG. 18 shows the heat seal curves for the M3410 EP/HL 328 films of this invention. It seems that the HL 328 does not have a very broad heat seal window while M3410 EP has in turn a very broad heat seal window, but its seal strength appears to be lower. Combining the two might improve M3410EP seal strength and broaden the seal window of HL 328. The curves in FIG. 18 do not extend far enough to give a complete answer or a trend prediction.

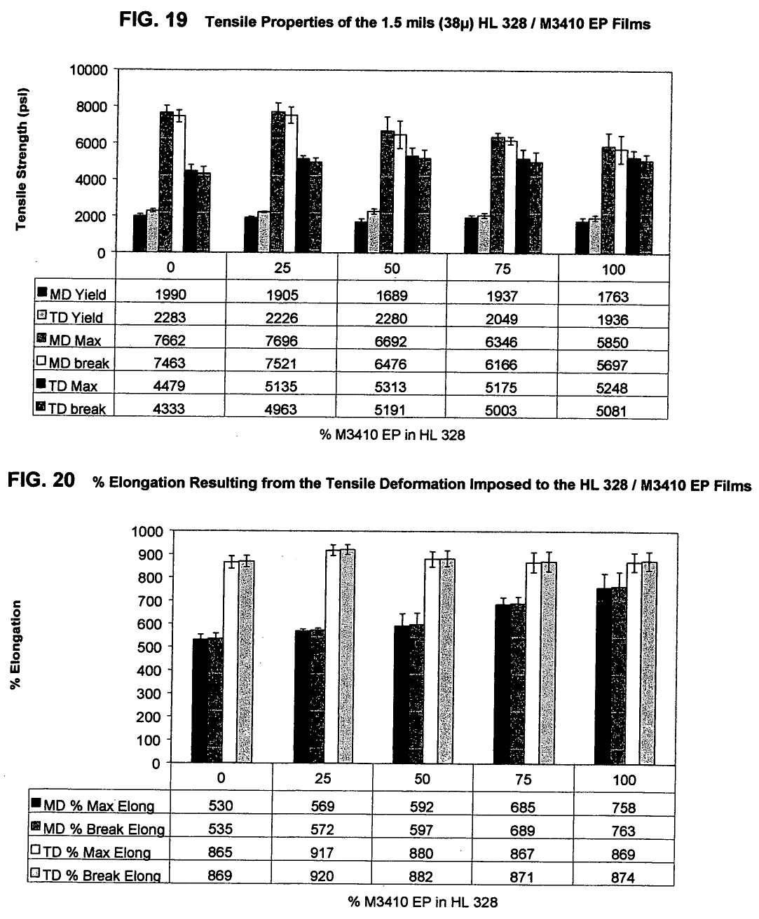

FIG. 19 presents the results from the tensile tests done for the HL 328/M3410 EP films. The yield strength was not affected by blending HL 328/M3410 EP regardless of the percentage of the blend. Furthermore, the yield strength in the MD and TD are very similar. On the other hand, the MD maximum and break strengths can decrease by about 20% as the amount of M3410 EP increases. The opposite can be said for the TD maximum and break strengths, but the change takes place after adding 25% M3410 EP in HL 328 rather than progressively as happened in the machine direction.

FIG. 20 presents the % elongation results from the tensile tests done for the HL 328/M3410 EP films. For the transverse direction, % elongation was not affected regardless of the percentage of M3410 EP in HL 328. On the other hand, the MD % elongation linearly increases as the amount of M3410 EP increases.

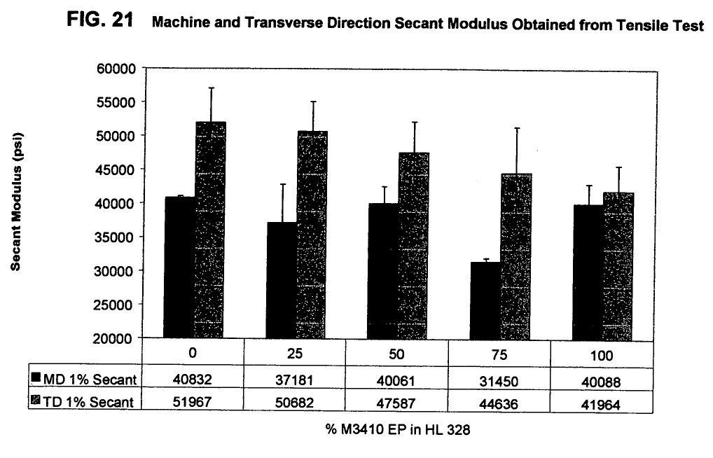

FIG. 21 presents the machine and transverse direction secant modulus for the HL 328/M3410 film blends. No change in the MD secant modulus took place with the addition of M3410 EP, while the TD secant modulus did decrease as the percentage of M3410 EP present in the blend increases. The blends with higher amount of M3410 EP produce films that are less stiff.

In conclusion, the seal initiation temperature of Examples 8-10 was not affected by blending M3410 EP with HL 328. In general, as the proportion of M3410 EP increases in the blend, the film becomes less stiff in the transverse direction while the stiffness in the machine direction is maintained. The increase observed in the TD maximum and TD break strengths took place after the addition of 25% M3410 EP while the MD maximum and break strengths can decrease by about 20% as the amount of M3410 EP increases. Excellent gloss, haze, and tear results (close to those of 100% M3410 EP) can be obtained when blending 50 to 75% M3410 EP in HL 328.

In the foregoing specification, the invention has been described with reference to specific embodiments thereof, and has been demonstrated as effective in providing methods for preparing blown films having improved properties. However, it will be evident that various modifications and changes can be made thereto without departing from the scope of the invention as set forth in the appended claims. Accordingly, the specification is to be regarded in an illustrative rather than a restrictive sense. For example, specific combinations or proportions of polymers and other components falling within the claimed parameters, but not specifically identified or tried in a particular polymer blend formulation, are anticipated and expected to be within the scope of this invention. Further, the methods of the invention are expected to work at other conditions, particularly extrusion and blowing conditions, than those exemplified herein. Additionally, the inventive blends of this invention may be expected to permit sheets or films to be down gauged with comparable properties, resulting in a savings on material.

TABLE VI
ASTM Film Test Methods Used in this Invention

| Property | ASTM Procedure |
|---|---|
| Tensile Strength, Elongation, Modulus | D882 |
| Haze | D1003 |
| Gloss | D2457 |
| Seal Testing | F88 |

What is claimed is:

1. A film or sheet material comprising a blend of:
at least one medium density polyethylene made using a metallocene catalyst (mMDPE) and
from about 10 to about 90 wt % of at least one second polyolefin, where the second polyolefin is selected from the group consisting of
a low density polyethylene (LDPE), and
a second medium density polyethylene (2dMDPE).

2. The film or sheet material of claim 1 where the mMDPE has a melt index (MI₂) of from about 0.20 to about 20 dg/min, a density of about 0.905 to about 0.961 gr/cm³, a polydispersity of less than 4.0, and a melting point of about 100 to about 135° C.

3. The film or sheet material of claim 1 where the LDPE has a melt index (MI₂) of from about 0.20 to about 20.0 g/10 min, a density of about 0.900 gr/cm³ to about 0.928 gr/cm³, a melting point of about 95 to about 125° C., and a tensile modulus from about 25 to about 35 kpsi.

4. The film or sheet material of claim 1 where the 2dMDPE has a melt index (MI₂) of from about 0.1 to about 10 dg/min, a density of about 0.925 to about 0.950 gr/cm³, a melting point of about 120 to about 132° C.

5. The film or sheet material of claim 1 where the second polyolefin is present in an amount from about 20 to 80 wt %.

6. The film or sheet material of claim 1 where the material has a reduction in motor amps as compared with an identical material absent the second polyolefin.

7. The film or sheet material of claim 1 where the material has improved hot tack results as compared with an identical material absent the second polyolefin.

8. The film or sheet material of claim 1 where the material has a reduction in sealing temperature as compared with an identical material absent the second polyolefin.

9. The film or sheet material of claim 1 where the material has an increase in machine direction tear resistance as compared with an identical material absent the second polyolefin.

10. The film or sheet material of claim 9 where the second polyolefin is LDPE and the second polyolefin proportion ranges from about 75 to about 95 wt %.

11. A copolymer resin blend comprising:
at least one medium density polyethylene made using a metallocene catalyst (mMDPE) and
from about 10 to about 90 wt % of at least one second polyolefin, where the second polyolefin is selected from the group consisting of
a low density polyethylene (LDPE), and
a second medium density polyethylene (2dMDPE).

12. The copolymer resin blend of claim 11 where the mMDPE has a melt index (MI₂) of from 0.20 to about 20 dg/min, a density of about 0.905 to about 0.961 gr/cm³, a polydispersity of less than 4.0, and a melting point of about 100 to about 135° C.

13. The copolymer resin blend of claim 11 where the LDPE has a melt index (MI₂) of from about 0.20 to about 20.0 g/10 min, a density of about 0.900 gr/cm³ to about 0.928 gr/cm³, a melting point of about 95 to about 125° C., and a tensile modulus from about 25 to about 35 kpsi.

14. The copolymer resin blend of claim 11 where the 2dMDPE has a melt index (MI₂) of from about 0.1 to about 10 dg/min, a density of about 0.925 to about 0.950 gr/cm³, a melting point of about 120 to about 132° C.

15. The copolymer resin blend of claim 11 where the second polyolefin is present in an amount from about 20 to 80 wt %.

16. A process for making a blown film comprising:
blending at least one medium density polyethylene made using a metallocene catalyst (mMDPE) with from about 10 to about 90 wt % of at least one second polyolefin, where the second polyolefin is selected from the group consisting of a low density polyethylene (LDPE), and a second medium density polyethylene (2dMDPE);
feeding the polymer blend to an extruder;
extruding the polymer blend through an annular die to form a molten tube; and
blowing the tube into a bubble using air to form a blown film structure.

17. The process of claim 16 where the mMDPE has a melt index (MI₂) of from 0.20 to about 20 dg/min, a density of about 0.905 to about 0.961 gr/cm³, a polydispersity of less than 4.0, and a melting point of about 100 to about 135° C.

18. The process of claim 16 where the LDPE has a melt index (MI₂) of from about 0.20 to about 20.0 g/10 min, a density of about 0.900 gr/cm³ to about 0.928 gr/cm³, a melting point of about 95 to about 125° C., and a tensile modulus from about 25 to about 35 kpsi.

19. The process of claim 16 where the 2dMDPE has a melt index (MI₂) of from about 0.1 to about 10 dg/min, a density of about 0.925 to about 0.950 gr/cm³, a melting point of about 120 to about 132° C.

20. The process of claim 16 where the second polyolefin is present in an amount from about 20 to 80 wt %.

21. The process of claim 16 where the extruding has a reduction in motor amps as compared with an identical material absent the second polyolefin.

22. The process of claim 16 where the resulting blown film has improved hot tack results as compared with an identical material absent the second polyolefin.

23. The process of claim 16 where the resulting blown film has a reduction in sealing temperature as compared with an identical material absent the second polyolefin.

24. The process of claim 16 where the resulting blown film has an increase in machine direction tear resistance as compared with an identical material absent the second polyolefin.

25. The process of claim 24 where the second polyolefin is LDPE and the second polyolefin proportion ranges from about 75 to about 95 wt %.

26. A process for making a multilayer film or sheet material comprising co-extruding at least two resins together where one of the resins is a resin blend comprising:
at least one medium density polyethylene made using a metallocene catalyst (mMDPE) and
from about 10 to about 90 wt % of at least one second polyolefin, where the second polyolefin is selected from the group consisting of
a low density polyethylene (LDPE), and
a second medium density polyethylene (2dMDPE).

27. The process of claim 26 further comprising making a three-layer film or sheet material by co-extruding the resin blend as the internal layer.

28. A co-extruded, multilayer film or sheet material made by the process of claim 26.

29. A process for making a laminated article having at least two layers comprising:
blending at least one medium density polyethylene made using a metallocene catalyst (mMDPE) with from about 10 to about 90 wt % of at least one second polyolefin, where the second polyolefin is selected from the group consisting of a low density polyethylene (LDPE), and a second medium density polyethylene (2dMDPE);
feeding the polymer blend to an extruder;
extruding the polymer blend through a die to form a first film or sheet material; and
adhering the first film or sheet material to at least one second film or sheet material.

30. A laminated article made by the process of claim 29.
